(19) United States
(12) Patent Application Publication
(10) Pub. No.: US 2010/0080616 A1
(43) Pub. Date: Apr. 1, 2010

(54) IMAGE FORMING APPARATUS AND PROCESS CARTRIDGE

(75) Inventor: Naoya KAMIMURA, Ichinomiya-shi (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, AICHI-KEN (JP)

(21) Appl. No.: 12/568,216

(22) Filed: Sep. 28, 2009

(30) Foreign Application Priority Data
Sep. 29, 2008 (JP) 2008-249572

(51) Int. Cl. G03G 21/18; G03G 21/00

(52) U.S. Cl. 399/111; 399/343; 399/346

(57) ABSTRACT

An image forming apparatus includes: a rotatable photosensitive member; an exposure member, which includes a plurality of blinking units arranged in an axial direction of the photosensitive member, and which exposes the photosensitive member; a pair of spacing members that holds a space between the photosensitive member and the exposure member by being in contact with the photosensitive member; and a pair of cleaning members that slidably contacts with the photosensitive member to remove extraneous matter from the photosensitive member. The pair of spacing members and the pair of cleaning members are disposed at corresponding positions in the axial direction of the photosensitive member.

This application claims priority from Japanese Patent Application No. 2008-249572 filed on Sep. 29, 2008, the entire subject matter of which is incorporated herein by reference.

### TECHNICAL FIELD

The invention relates to an image forming apparatus including a pair of spacing members for holding a space between a photosensitive member and an exposure member, and a process cartridge that is removably mounted to the image forming apparatus.

### BACKGROUND

As an image forming apparatus that exposes a photosensitive drum with an LED head, there has been proposed a known image forming apparatus including a roller (spacing member) for holding a space in a optical axis direction between the LED head and the photosensitive drum. The roller is provided between the LED head and the photosensitive drum. Specifically, in the known image forming apparatus, the roller is rotatably provided on the LED head, and the roller contacts with the photosensitive drum so as to hold the space in the optical axis direction between the LED head and the photosensitive drum.

### SUMMARY

Illustrative aspects of the invention provide an image forming apparatus that can reduce an occurrence of a printing failure by suppressing wear of spacing members, and a process cartridge that is removably mounted to the image forming apparatus.

### BRIEF DESCRIPTION OF THE DRAWINGS

FIG. 1 is a schematic sectional view an image forming apparatus according to an exemplary embodiment of the invention;

FIG. 2 is an enlarged view showing an LED unit and a process cartridge of the image forming apparatus;

FIG. 3 is a schematic front view around a photosensitive drum of the image forming apparatus;

FIG. 4 is an enlarged sectional view of the image forming apparatus, showing a state where a cleaning member is in a charge position; and

FIG. 5 is another enlarged sectional view of the image forming apparatus, showing a state where the cleaning member is provided at a position, which is downstream from a development position and upstream from a transfer position.

### DETAILED DESCRIPTION

### General Overview

In the known image forming apparatus, if foreign matter such as paper dust and developer adheres on the peripheral surface of the photosensitive drum, the foreign matter is caught between the photosensitive drum and roller to make sliding contact with the roller, and thus the roller surface may be gradually scraped. In addition, if the roller surface is scraped, the space in the optical axis direction between the LED head and the photosensitive drum changes, and a printing failure may be occurred.

Therefore, illustrative aspects of the invention provide an image forming apparatus that can reduce an occurrence of a printing failure by suppressing wear of spacing members, and a process cartridge that is removably mounted to the image forming apparatus.

According to a first illustrative aspect of the invention, there is provided an image forming apparatus comprising: a rotatable photosensitive member; an exposure member, which comprises a plurality of blinking units arranged in an axial direction of the photosensitive member, and which exposes the photosensitive member; a pair of spacing members that holds a space between the photosensitive member and the exposure member by being in contact with the photosensitive member; and a pair of cleaning members that slidably contacts with the photosensitive member to remove extraneous matter from the photosensitive member, wherein the pair of spacing members and the pair of cleaning members are disposed at corresponding positions in the axial direction of the photosensitive member.

According to a second illustrative aspect of the invention, there is provided a process cartridge that is removably mounted to an image forming apparatus, the image forming apparatus comprising an exposure member and a pair of spacing members provided in the exposure member, the process cartridge comprising: a rotatable photosensitive member, which is exposed by the exposure member, and which contacts with the pair of spacing members when the process cartridge is mounted to the image forming apparatus; and a pair of cleaning members that slidably contacts with the photosensitive member to remove extraneous matter from the photosensitive member, wherein the pair of spacing members and the pair of cleaning members are disposed at corresponding positions in an axial direction of the photosensitive member when the process cartridge is mounted to the image forming apparatus.

Here, the “axial direction of the photosensitive member” means, when the photosensitive member is a photosensitive drum, an axial direction thereof, and when the photosensitive member is composed of a belt and a support shaft that rotatably supports the belt, an axial direction of the support shaft.

According to the illustrative aspects of the invention, the pair of spacing members and the pair of cleaning members being in contact with the photosensitive member are positioned at corresponding positions in the axial direction of the photosensitive member. Therefore, even when foreign matter stuck to a position of the photosensitive member corresponding to the spacing members moves toward the spacing members as a result of rotation of the photosensitive member, the foreign matter is wiped away by the cleaning members before reaching the spacing members. Therefore, wear of the spacing members due to the foreign matter can be suppressed, and the occurrence of a printing failure can be suppressed.

According to the illustrative aspects of the invention, the pair of spacing members and the pair of cleaning members being in contact with the photosensitive member are positioned at corresponding positions in the axial direction of the photosensitive member. Therefore, by wiping away foreign matter by the cleaning members, wear of the spacing members can be suppressed, and the occurrence of a printing failure can be suppressed.

### EXEMPLARY EMBODIMENTS

Exemplary embodiments of the invention will now be described with reference to the drawings.

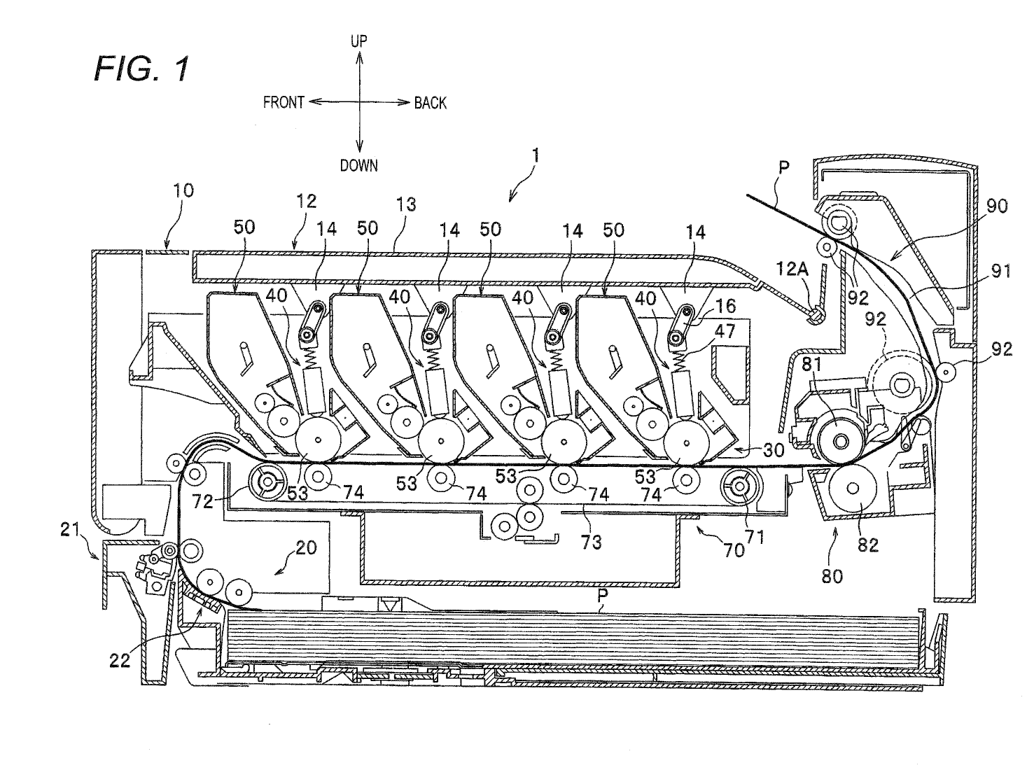

In the following, description will be given with directions on the basis of a user when using an image forming apparatus. More specifically, in FIG. 1, the left-hand side of the page is referred to as the “front side (near side),” and the right-hand side of the page, as the “back side (further side),” and the further side of the page is referred to as the “left side,” and the near side, as the “right side.” In addition, the upper and lower direction of the page is referred to as the “up-down direction.”

As shown in FIG. 1, an image forming apparatus 1 according to the exemplary embodiment of the invention includes a body casing 10, a feeder unit 20 that feeds a sheet P (one example of a transfer medium), an image forming unit 30 that forms an image on a fed sheet P, and a sheet discharge part 90 that discharges a sheet P on which an image has been formed. Incidentally, the feeder unit 20, the image forming unit 30 and the sheet discharge part 90 are provided in the body casing 10. Incidentally, color printer is one example of the image forming apparatus 1.

The body casing 10 is provided at an upper part thereof with an upper cover 12 that is freely openable and closable relative to the body casing 10, so as to be freely rotatable up and down using a hinge 12A provided at a back side as a fulcrum. An upper surface of the upper cover 12 serves as a sheet discharge tray 13 to stack sheets P discharged from the body casing 10, and provided on a lower surface thereof are a plurality of LED fitting members 14 to hold LED units 40 to be described later.

The feeder unit 20 is provided at a lower part in the body casing 10, and includes a sheet feeding tray 21 that is detachably attached to the body casing 10 and a sheet feeding mechanism 22 that conveys a sheet P from the sheet feeding tray 21 to the image forming unit 30. In the feeder unit 20, sheets P within the sheet feeding tray 21 are separated one by one by the sheet feeding mechanism 22 and fed to the image forming unit 30.

The image forming unit 30 includes four LED units 40, four process cartridges 50, a transfer unit 70, and a fixing unit 80.

Each LED unit 40 is swingably supported by a connecting member 16 that is connected so as to be swingable with respect to the LED fitting member 14, and is supported while being appropriately positioned by a positioning member provided on the body casing 10. A detailed structure of the LED unit 40 will be described later.

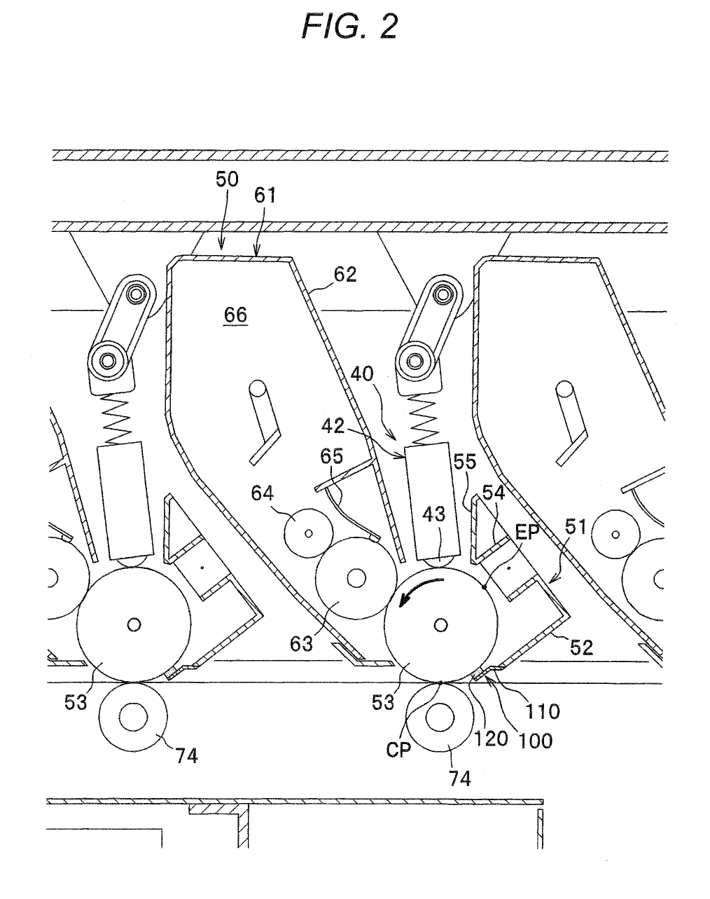

The process cartridges 50 are disposed side by side in the front-back direction between the upper cover 12 and the feeder unit 20, and each includes, as shown in FIG. 2, a drum unit 51 and a developing unit 61 that is detachably attached to the drum unit 51. The process cartridges 50 differ from each other only in the color of developer to be accommodated in a developer accommodation chamber 66 of the developing unit 61, and are identical in configuration. Incidentally, toner is one example of the developer.

The drum unit 51 includes a drum frame 52, a photosensitive drum 53 (one example of a photosensitive member) that is rotatably supported on the drum frame 52, and a charger 54.

The developing unit 61 has a developing frame 62, a developing roller 63 and a supply roller 64 that are rotatably supported on the developing frame 62, a layer thickness control blade 65, and a developer accommodation chamber 66 that accommodates developer. The process cartridge 50 has an exposure hole 55 that is formed between the developing frame 62 and the drum frame 52 as a result of the developing unit 61 being attached to drum unit 51, and disposed below the exposure hole 55 is the photosensitive drum 53. In addition, as a result of the LED unit 40 being inserted in the exposure hole 55, the LED unit 40 is disposed opposed to the photosensitive drum 53.

As shown FIG. 1, the transfer unit 70 is provided between the feeding unit 20 and the process cartridges 50, and includes a driving roller 71, a driven roller 72, a conveyance belt 73, and a transfer roller 74.

The driving roller 71 and the driven roller 72 are disposed parallel to each other separated in the front-back direction, and provided therebetween in a tensioned manner is the conveyance belt 73 formed of an endless belt. The conveyance belt 73 is in contact at an outside surface thereof with the photosensitive drums 53. Moreover, inside of the conveyance belt 73, four transfer rollers 74 that sandwich the conveyance belt 73 with the photosensitive drums 53 are disposed opposed to the photosensitive drums 53, respectively. The transfer roller 74 is applied at the time of transfer with a transfer bias by constant current control.

The fixing unit 80 is disposed on the further side of the process cartridges 50 and the transfer unit 70, and includes a heating roller 81 and a pressure roller 82 that is disposed opposed to the heating roller 81 and presses the heating roller 81.

In the image forming unit 30, first, the surface of each photosensitive drum 53 is uniformly charged with electricity by the charger 54, and then exposed with light irradiated from each LED unit 40. Accordingly, potential of the exposed part is lowered, and an electrostatic latent image based on image data is formed on each photosensitive drum 53.

Moreover, the developer in the developer accommodation chamber 66 is supplied to the developing roller 63 as a result of rotation of the supply roller 64, and enters between the developing roller 63 and the layer thickness control blade 65 as a result of rotation of the developing roller 63 to be carried on the developing roller 63 as a thin layer of a constant thickness.

The developer carried on the developing roller 63 is supplied to the electrostatic latent image formed on the photosensitive drum 53 when the developing roller 63 contacts the photosensitive drum 53 opposed thereto. Accordingly, the developer is selectively carried on the photosensitive drum 53 to make the latent image visible, and a developer image is formed by reversal development.

Next, as a result of a sheet P fed onto the conveyance belt 73 passing through between each photosensitive drum 53 and each transfer roller 74 disposed inside of the conveyance belt 73, the developer image formed on each photosensitive drum 53 is transferred onto the sheet P. Then, as a result of the sheet P passing through between the heating roller 81 and the pressure roller 82, the developer image transferred onto the sheet P is heat fixed.

The sheet discharge part 90 includes a sheet discharge-side conveying path 91 formed so as to extend upward from an exit of the fixing unit 80 and be turned over to the near side and a plurality of pairs of conveying rollers 92 for conveying a sheet P. The sheet P that has been transferred with the developer image and heat fixed is conveyed along the sheet discharge-side conveying path 91 by the conveying rollers 92, and discharged outside the body casing 10 to be stacked in the sheet discharge tray 13.

Next, the configuration around the photosensitive drum 53, which is a feature of the invention, will be described.

As shown in FIG. 2, disposed around the photosensitive drum 53 is the LED unit 40 and a cleaning member 100.

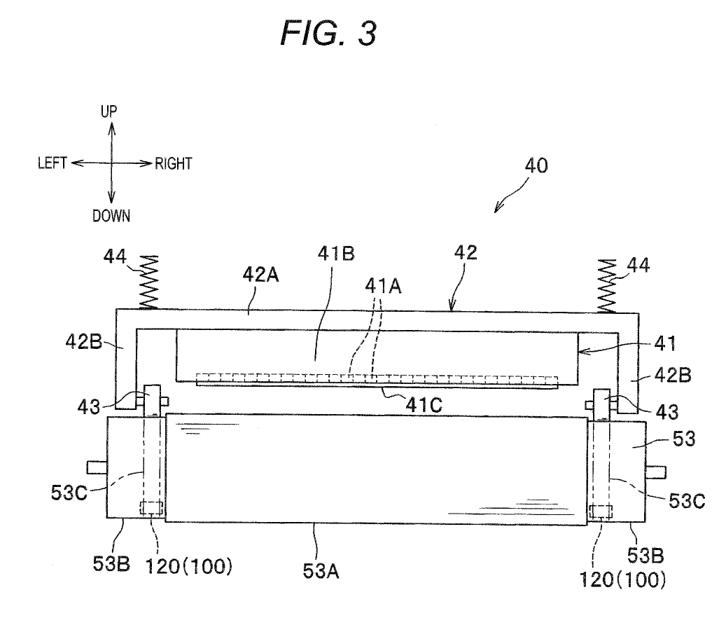

As shown in FIG. 3, the LED unit 40 includes an LED head 41 (one example of an exposure member), a support frame 42, and a pair of guide rollers 43, which are examples of spacing members.

The LED head 41 includes a plurality of LED arrays 41A formed by arranging a large number of LEDs on a semiconductor chip, a head frame 41B, and a lens array 41C. In the exemplary embodiment, a blinking unit is composed of a plurality of LED arrays 41A and a lens array 41C, for example.

The plurality of LED arrays 41A are arranged in a line in the right-left direction (axial direction of the photosensitive drum 53), appropriately emit light by being selectively driven so as to irradiate light toward the photosensitive drum 53. Specifically, each LED array 41A is, based on data of an image to be formed, input with a signal by a control unit (not shown) to emit light and expose the photosensitive drum 53.

The head frame 41B is formed of a resin, and supports a plurality of LED arrays 41A on a lower part thereof. Also, as a result of the head frame 41B being formed of a resin, the LED head 41 is reduced in size and cost, and discharge of electricity from a high-voltage component such as a charger is suppressed.

The lens array 41C, for which a plurality of SELFOC lenses (registered trademark) are arranged, extends along the arranging direction of the LED arrays 41A, and is fixed to the head frame 41B.

The support frame 42 includes a base portion 42A extending in the right-left direction and a pair of extending portions 42B extending downward from both ends of the base portion 42A. On a lower surface of the base portion 42A, the LED head 41 is provided, and at a lower part of each extending portion 42B, the guide roller 43 is rotatably provided. In addition, the base portion 42A is supported by the connecting member 16 (see FIG. 1) described above via a coil spring 44.

The guide roller 43 is a circular cylindrical member, and as a result of being transmitted with a pressing force from the coil spring 44 described above via the support frame 42, is pressed against the photosensitive drum 53 to rotate while following the photosensitive drum 53. The guide roller 43, as a result of making contact with the photosensitive drum 53, even if the photosensitive drum 53 is eccentric, holds a space in the optical axis direction between the photogenic drum 53 and the LED head 41 supported by the support frame 42. In addition, each guide roller 43 is disposed in a region (i.e., a non-applied region 53B where a photosensitive layer 53A is not applied) at a more outer side in the right-left direction than the photosensitive layer 53A to be applied to the surface of the photosensitive drum 53.

Here, the photosensitive drum 53 is formed by applying the photosensitive layer 53A to a center part of a metallic base tube, and each guide roller 43 rolls on the surface (non-applied region 53B) of the metallic base tube. Moreover, the width of the photosensitive layer 53A (length in the axial direction of the photosensitive drum 53) is formed larger than the width of the developing roller 63 (see FIG. 2). Accordingly, the developing roller 63 is brought into contact with the photosensitive layer 53A over the entire axial direction.

As shown in FIG. 2, each of the cleaning member 100 includes a flexibly deformable film 110 and a sponge 120 stuck to the tip of the film 110. The film 110 is in a state flexed by a predetermined amount fixed at a base end portion thereof to the drum frame 52. Accordingly, the film 110 presses the sponge 120 against the photosensitive drum 53 to remove extraneous matter (paper dust etc.) on the photosensitive drum 53.

Here, a lubricant including a fluorinated oil and a fluorinated resin may be applied to the sponge 120. According thereto, the sponge 120 satisfactorily slips on the surface of the photosensitive drum 53 and smoothly rotates the photosensitive drum 53. Incidentally, as for the lubricant, for example, HANARL manufactured by Kanto Kasei LTD or the like can be adopted.

As shown in FIG. 3, the sponges 120 of the cleaning members 100 are provided as a left and right pair such that each of the sponges 120 slidingly contacts the photosensitive drum 53. Each of the sponges 120 is disposed in the axial direction of the photosensitive drum 53 at the same positions (corresponding positions) as those of the respective guide rollers 43. More specifically, the sponge 120 of each cleaning member 100 is, similar to each guide roller 43, disposed in the non-applied region 53B where the photosensitive layer 53A is not applied. More specifically, the sponge 120 is formed larger than the width of a region 53C where the guide roller 43 makes contact with the photosensitive drum 53 shown by alternative long and two short dashed lines in the figure (width in the axial direction of the photosensitive drum 53), and slidingly contacts the photosensitive drum 53 so as to entirely cover the region 53C. Accordingly, the entirety of the region 53C where the guide roller 43 contacts the photosensitive drum 53 is reliably wiped away by the sponge 120.

Moreover, the sponge 120 is, as shown in FIG. 2, disposed at a more downstream side in the rotating direction of the photosensitive drum 53 than a transfer position CP and at a more upstream side in the rotating direction than a charge position EP. Here, the “transfer position CP” means a position to transfer a developer image formed on the photosensitive drum 53 to a sheet P, and the “charge position EP” is a position where the photosensitive drum 53 is charged by the charger 54, which means a position in the vicinity of the charger 54 to charge the photosensitive drum 53. In addition, as a result of the sponge 120 being disposed as such, paper dust generated at the transfer position CP due to sliding contact between the sheet P and the photosensitive drum 53 and the like can be immediately wiped away by the sponge 120.

According to the exemplary embodiments of the invention, the pair of guide rollers 43 and the pair of cleaning members 100 (sponges 120) being in contact with the photosensitive drum 53 are positioned at the same positions in the axial direction of the photosensitive drum 53. Therefore, by wiping away foreign matter by the cleaning members 100, wear of the guide rollers 43 can be suppressed, and thus the occurrence of a printing failure can be suppressed.

According to the exemplary embodiments of the invention, the guide roller 43 and the cleaning member 100 are disposed in the non-applied region 53B of the photosensitive drum 53 where the photosensitive layer 53A is not applied. Therefore, the photosensitive layer 53A is not scraped by the guide roller 43 or the cleaning member 100. Therefore, in comparison with a configuration where the guide roller 43 or the like is disposed on the photosensitive layer 53A, it is possible to prevent a situation where the position of the guide roller 43 changes due to scraping of the photosensitive layer 53A so that the space in the optical axis direction between the photosensitive drum 53 and the LED head 41 is changed.

According to the exemplary embodiments of the invention, by disposing the guide roller 43 and the like in the non-applied region 53B, the photosensitive layer 53A is not scraped by the guide roller 43 or the like. Thus, the developing roller 63 can always hit against the photosensitive layer 53A. In contrast, when the guide roller 43 and the like is disposed on the photosensitive layer 53A, if the photosensitive layer 53A is scraped by the guide roller 43 or the like to expose the metallic base tube, the exposed part may make contact with the developing roller 63. In this case, potential of the developing roller 63 drops to make it difficult to keep the developer by the developing roller 63. However, when the guide roller 43 and the like is disposed in the non-applied region 53B, the developing roller 63 can always hit against the photosensitive layer 53A while preventing the guide roller 43 or the like from scraping the photosensitive layer 53A. Therefore, the developer can be reliably kept by the developing roller 63.

According to the exemplary embodiments of the invention, the cleaning member 100 (sponge 120) is disposed at a more downstream side in the rotating direction of the photosensitive drum 53 than the transfer position CP and at a more upstream side in the rotating direction than the charge position EP. Therefore, paper dust generated from a sheet P at the transfer position CP can be satisfactorily wiped away by the cleaning member 100 immediately after paper dust is generated.

According to the exemplary embodiments of the invention, the cleaning member 100 of the film 110 and the sponge 120 allows pressing the sponge 120 with an appropriate force against the photosensitive drum 53 by an elastic force of the film 110. Therefore, a load to be applied to the photosensitive drum 53 from the sponge 120 can be suppressed, and the photosensitive drum 53 can be smoothly rotated.

The invention can be used in various modes as will be exemplified in the following, without being limited to the above-described exemplary embodiment.

In the above-described exemplary embodiment, the film 110 and the sponge 120 stuck together has been adopted as a cleaning member, however, the invention is not limited thereto, and for example, a cleaning member may be composed only of a film, only of a sponge, only of a felt, or the like.

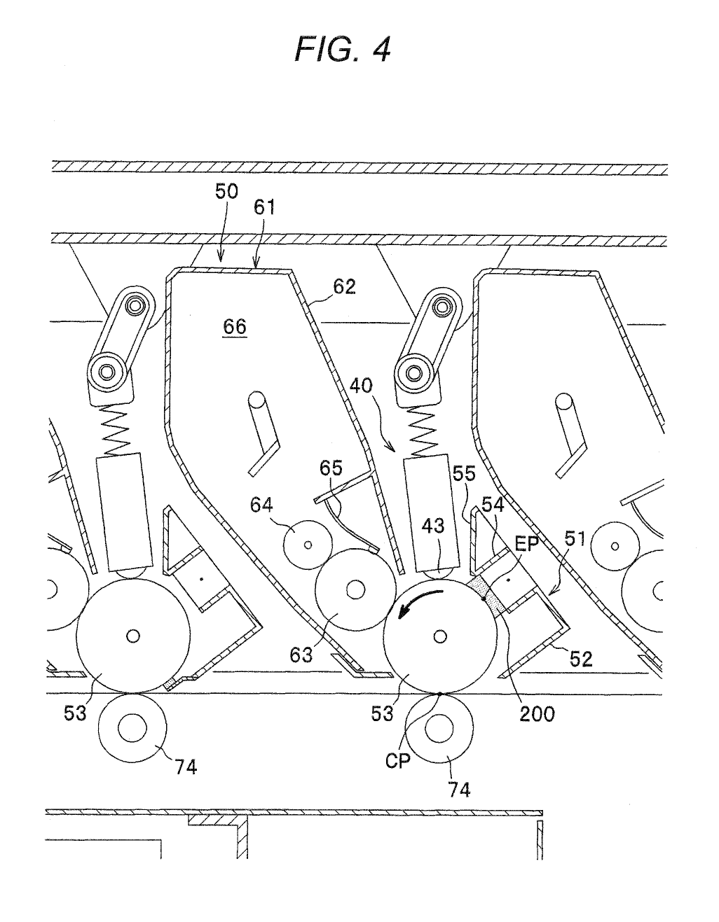

In the above-described exemplary embodiment, the position of the cleaning member 100 (sponge 120) in the peripheral direction of the photosensitive drum 53 has been provided at a more downstream side in the rotating direction than the transfer position CP and a more upstream side in the rotating direction of the photosensitive drum 53 than the charge position EP, however, the invention is not limited thereto. For example, as shown in FIG. 4, a cleaning member 200 composed only of a sponge may be arranged at the charge position EP. Specifically, the cleaning members 200 may be provided one each at both left and right sides of the charger 54. Because this allows wiping the surface of the photosensitive drum 53 by the cleaning members 200 immediately before exposing the photosensitive drum 53 with the LED unit 40, the possibility that paper dust etc., again adheres to the photosensitive drum 53 until the photosensitive drum 53 is exposed after being wiped is low. Therefore, wear of the guide rollers 43 can be more reliably suppressed, and this allows more reliably suppressing the occurrence of a printing failure.

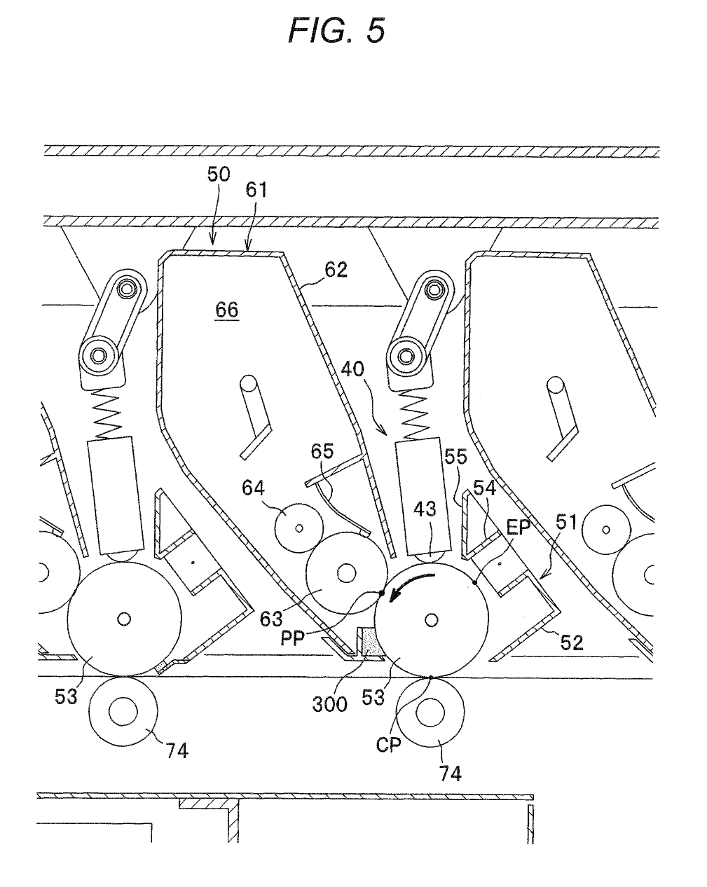

Alternatively, as shown in FIG. 5, a cleaning member 300 composed only of a sponge may be disposed at a more downstream side in the rotating direction of the photosensitive drum 53 than a development position PP and at a more upstream side in the rotating direction than the transfer position CP. Specifically, the cleaning members 300 may be provided one each at both left and right sides in the drum frame 52. Here, the “development position PP” is a position to supply developer from the developing roller 63 to the photosensitive drum 53, which means a position to develop an electrostatic latent image formed on the photosensitive drum 53 into a developer image. Therefore, even when the developer spreads from the development position PP, the spread developer can be wiped before the spread developer reaches the transfer position CP, and a sheet P can be suppressed from being stained.

In the present embodiment, the invention has been applied to the image forming apparatus 1, however, the invention is not limited thereto, and the invention may be applied to other image forming apparatuses such as, for example, copiers and multifunction devices.

In the above-described exemplary embodiment, the photosensitive drum 53 has been adopted as a photosensitive member, however, the invention is not limited thereto, and a belt-like photosensitive member may be adopted, for example.

In the above-described exemplary embodiment, the LED head 41 including the plurality of LED arrays 41A arranged in a line in the right-left direction and the lens array 41C has been adopted as an exposure member, however, the invention is not limited thereto. For example, an LED head having a plurality of LED arrays and the like arranged in the right-left direction at the front and back in a plurality of lines may be adopted as an exposure member. Moreover, a single light emitting element such as an LED or a fluorescence light and optical shutters of a plurality of liquid crystals or PLZT devices arranged in the right-left direction outside the light emitting element may compose a plurality of blinking units, and a member having such blinking units may be adopted as an exposure member. Moreover, a light source of the exposure member may be an EL (Electro Luminescence) element, a phosphor, or the like, without limitation to an LED.

In the above-described exemplary embodiment, the rotatable guide roller 43 has been adopted as a spacing member, however, the invention is not limited thereto, and a non-rotating member may be adopted as a spacing member. Moreover, as the transfer medium, without limitation to a sheet P, an intermediate transfer belt and the like may be adopted, for example.

What is claimed is:

1. An image forming apparatus comprising:
a rotatable photosensitive member;
an exposure member, which comprises a plurality of blinking units arranged in an axial direction of the photosensitive member, and which exposes the photosensitive member;
a pair of spacing members that holds a space between the photosensitive member and the exposure member by being in contact with the photosensitive member; and
a pair of cleaning members that slidably contacts with the photosensitive member to remove extraneous matter from the photosensitive member,
wherein the pair of spacing members and the pair of cleaning members are disposed at corresponding positions in the axial direction of the photosensitive member.

2. The image forming apparatus according to claim 1,
wherein a photosensitive layer is applied on the photosensitive member, and
wherein the spacing member and the cleaning member are disposed in a non-applied region of the photosensitive member where the photosensitive layer is not applied.

3. The image forming apparatus according to claim 1, further comprising a charger that charges the photosensitive member at a charge position,
wherein the cleaning member is provided at the charge position.

4. The image forming apparatus according to claim 1,
wherein the cleaning member is provided at a position, which is downstream in a rotating direction of the photosensitive member from a development position where an electrostatic latent image formed on the photosensitive member is developed into a developer image, and which is upstream in the rotating direction of the photosensitive member from a transfer position where the developer image formed on the photosensitive member is transferred to a transfer medium.

5. The image forming apparatus according to claim 1, further comprising a charger that charges the photosensitive member at a charge position,
wherein the cleaning member is provided at a position, which is downstream in a rotating direction of the photosensitive member from a transfer position where a developer image formed on the photosensitive member is transferred to a transfer medium, and which is upstream in the rotating direction of the photosensitive member from the charge position.

6. The image forming apparatus according to claim 1, further comprising:
a charge unit that charges the photosensitive member; and
a developing roller that supplies developer to the photosensitive member,
wherein the exposure member exposes the photosensitive member charged by the charge unit so as to form an electrostatic latent image on the photosensitive member,
wherein the developing roller supplies the developer to the electrostatic latent image on the photosensitive member so as to develop the electrostatic latent image to a developer image, and
wherein the photosensitive member transfers the developer image formed on the photosensitive member to a transfer medium.

7. The image forming apparatus according to claim 1,
wherein the cleaning member comprises:
a flexibly deformable film; and
a sponge that is sticked to the flexibly deformable film.

8. The image forming apparatus according to claim 7,
wherein the sponge is applied with a lubricant including a fluorinated oil and a fluorinated resin.

9. The image forming apparatus according to claim 1,
wherein the cleaning member comprises a sponge, with which a lubricant including a fluorinated oil and a fluorinated resin is applied.

10. A process cartridge that is removably mounted to an image forming apparatus, the image forming apparatus comprising an exposure member and a pair of spacing members provided in the exposure member, the process cartridge comprising:
a rotatable photosensitive member, which is exposed by the exposure member, and which contacts with the pair of spacing members when the process cartridge is mounted to the image forming apparatus; and
a pair of cleaning members that slidably contacts with the photosensitive member to remove extraneous matter from the photosensitive member,
wherein the pair of spacing members and the pair of cleaning members are disposed at corresponding positions in an axial direction of the photosensitive member when the process cartridge is mounted to the image forming apparatus.

11. The process cartridge according to claim 10,
wherein a photosensitive member is applied on the photosensitive member, and
wherein the cleaning member is disposed in a non-applied region of the photosensitive member where the photosensitive layer is not applied.

12. The process cartridge according to claim 10, further comprising a charger that charges the photosensitive member at a charge position,
wherein the cleaning member is provided at the charge position.

13. The process cartridge according to claim 10,
wherein the cleaning member is provided at a position, which is downstream in a rotating direction of the photosensitive member from a development position where an electrostatic latent image formed on the photosensitive member is developed into a developer image, and which is upstream in the rotating direction of the photosensitive member from a transfer position where the developer image formed on the photosensitive member is transferred to a transfer medium.

14. The process cartridge according to claim 10, further comprising a charger that charges the photosensitive member at a charge position,
wherein the cleaning member is provided at a position, which is downstream in a rotating direction of the photosensitive member from a transfer position where a developer image formed on the photosensitive member is transferred to a transfer medium, and which is upstream in the rotating direction of the photosensitive member from the charge position.

15. The process cartridge according to claim 1,
wherein the cleaning member comprises:
a flexibly deformable film; and
a sponge that is sticked to the flexibly deformable film.

16. The process cartridge according to claim 15,
wherein the sponge is applied with a lubricant including a fluorinated oil and a fluorinated resin.

17. The process cartridge according to claim 10,
wherein the cleaning member comprises a sponge, with which a lubricant including a fluorinated oil and a fluorinated resin is applied.
